(19) United States
(12) Patent Application Publication
(10) Pub. No.: US 2016/0146616 A1
(43) Pub. Date: May 26, 2016

(54) VEHICLE POSITIONING BY MAP MATCHING AS FEEDBACK FOR INS/GPS NAVIGATION SYSTEM DURING GPS SIGNAL LOSS

(71) Applicant: Alpine Electronics, Inc., Tokyo (JP)

(72) Inventor: Ming Ren, Torrance, CA (US)

(73) Assignee: Alpine Electronics, Inc.

(21) Appl. No.: 14/549,797

(22) Filed: Nov. 21, 2014

(51) Int. Cl. G01C 21/30; G01S 19/13; G01C 21/16

(52) U.S. Cl. CPC G01C 21/30; G01C 21/165; G01S 19/13

(57) ABSTRACT

A method and apparatus of vehicle positioning uses map matching as feedback for an integrated navigation system where a map and navigation system is coupled with an inertial navigation system (INS) using low-precision vehicle sensors when the vehicle passes through a tunnel or other area suffering from GPS signal loss. The method and apparatus operates to detect whether the vehicle has reached an entry point of a tunnel, and if so, immediately starts a map matching operation to match the current vehicle position with a road link of the tunnel. The current position determined by the map matching operation is feedbacked to an integration Kalman filter thereby correcting errors caused by the vehicle sensors. The method and apparatus resumes the normal navigation operation including GPS navigation as soon as it detects that the vehicle is out of the tunnel.

### FIELD OF THE INVENTION

This invention relates to a method and apparatus of vehicle positioning by using a smartphone positioning system and vehicle sensors made of low-precision Micro Electro Mechanical Sensors (MEMS). More particularly, this invention relates to a method and apparatus of vehicle positioning by using a map matching technology as feedbacks for compensating the positioning errors in an integrated INS/GPS navigation system for traveling an area in which sufficient Global Positioning System (GPS) signals are unavailable.

### BACKGROUND OF THE INVENTION

Today's high end vehicle includes processors, various sensors, and wired/wireless network to enable improved safety through a vehicle stability control and accident protection. For example, vehicle stability is controlled by detecting and reducing skidding (loss of traction) involved in a cornering action, brake action on wet surfaces of road, abrupt acceleration of a vehicle, etc. Sensors installed in a vehicle for this purpose of stability control include, for example, gyroscopes and three-dimensional accelerometers, among others.

Today's mobile phones, such as smartphones, provide more advanced computing capability and connectivity than traditional mobile phones. A smartphone typically includes features of a mobile phone with other popular consumer service, such as a personal digital assistant, a media player, a digital camera, a web browser and search engine, an electric book reader, motion sensor, a map and navigation system, etc. The map and navigation system is capable of detecting a current absolute position of the smartphone by analyzing GPS signals received from GPS satellites and guiding a user to an intended destination via a calculated route.

Recently, an attempt has been made to improve a navigation function by combining GPS capability of a smartphone and vehicle sensors for stability as schematically shown in FIG. 1. Typically, in such an attempt, the vehicle sensors are used to establish an inertial navigation system (INS). The INS is composed of an inertial measurement unit (IMU) and a processor where an IMU houses accelerometers and gyroscopes (inertial sensors) for detecting platform motions with respect to an inertial coordinate system.

The embodiments disclosed here are intended to further improve the capability of vehicle positioning when integrating the map and navigation system of the smartphone or any portable GPS-aided device and the INS using the vehicle sensors. As noted above, the map and navigation system is able to detect an absolute position of the user but requires GPS signals from a predetermined number (such as six) of GPS satellites. An important advantage of the INS is independence from external support signals, such as GPS signals from GPS satellites, thus it is self-contained. However, the INS cannot provide high accuracy at long ranges, because inertial sensors are subject to errors that tend to accumulate over time.

Since the map and navigation system relies on GPS signals from GPS satellites, it is susceptible to loss of signals, jamming, RF (radio frequency) interference and multipath problems depending on specific surroundings of the map and navigation system. For example, signal dropouts occur when the smartphone having the map and navigation system is in a downtown area of an urban canyon with multiple high-rise buildings, a tunnel, a parking structure, of an area with steep mountains and cliffs, etc. FIG. 2 schematically shows an example of such a situation where a vehicle 13 on a street 15 is approaching a tunnel 17 in which GPS signals are not available.

In the integrated vehicle sensor/map and navigation system, when the GPS signals for the map and navigation system is lost because the vehicle 13 enters the tunnel 17, the INS compensates the GPS signal loss by detecting platform motions with respect to the previously known absolute position, namely, a dead reckoning operation. However, as noted above, since the inertial sensors are subject to errors that tend to accumulate over time, if a tunnel is relatively long, it may not be able to determine the correct current vehicle position. Especially, since the vehicle stability sensors are not originally designed for the purpose of navigation but rather for the purpose of vehicle safety, such low level sensors may further be subject to errors, which further deteriorate the positioning accuracy.

Therefore, there is a need of a new method and apparatus for vehicle positioning by combining a smartphone and low-precision vehicle sensors which is capable of accurately determining a current position of the vehicle when the GPS signals are temporarily unavailable.

### SUMMARY OF THE INVENTION

It is, therefore, an object of the present disclosure to provide a method and apparatus for vehicle positioning by integrating a portable GPS device typically implemented by a smartphone and an inertial navigation system (INS) using low-precision vehicle sensors.

It is another object of the present disclosure to provide a method and apparatus for vehicle positioning by establishing an integrated INS/GPS navigation system where the vehicle sensors are made of low-precision Micro Electro Mechanical Sensors (MEMS) designed for vehicle safety and stability rather than vehicle navigation.

It is a further object of the present disclosure to provide a method and apparatus of vehicle positioning by using a map matching technology and providing the results as feedback thereof for compensating the vehicle sensor errors in an integrated INS/GPS navigation system for a tunnel in which GPS signals are not available.

It is a further object of the present disclosure to provide a method and apparatus of vehicle positioning by changing an operation of GPS navigation to an operation of INS incorporating the map matching technology at an optimum timing with respect to the tunnel through which the vehicle will travel.

It is a further an object of the present disclosure to provide a method and apparatus for vehicle positioning by integrating a smartphone GPS navigation device and an inertial navigation system (INS) using low-precision vehicle sensors in a loosely coupled manner where the vehicle sensor errors are compensated by the map matching technology when the vehicle enters the tunnel.

It is a further an object of the present disclosure to provide a method and apparatus for vehicle positioning by integrating a smartphone GPS navigation device and an inertial navigation system (INS) using low-precision vehicle sensors in a tightly coupled manner where the vehicle sensor errors are compensated by the map matching technology when the vehicle enters the tunnel.

It is a further object of the present disclosure to provide an example of application to be implemented by a smartphone for improving a vehicle positioning capability by establishing an integrated INS/GPS navigation system where the vehicle sensors for INS are made of low-precision Micro Electro Mechanical Sensors (MEMS) designed for vehicle stability rather than vehicle navigation.

It is a further object of the present disclosure to provide an example of application to be implemented by a smartphone for improving a vehicle positioning capability by establishing an integrated INS/GPS navigation system where the vehicle sensor errors are compensated by the results of the map matching operation when the vehicle travels through the tunnel.

One aspect of the present disclosure is directed to a vehicle positioning method for a navigation system established on a smartphone. The method is comprised of the steps of: integrating, by using a processor, an inertial navigation system (INS) incorporating vehicle sensors with a GPS (global positioning system) navigation system implemented on a smartphone with use of an integration Kalman filter; producing vehicle's position estimates by the INS based on the acceleration and angular rate measurements from the vehicle sensors; producing position estimates indicating an absolute position of the vehicle by the map and navigation system which receives GPS satellite signals from a plurality of GPS satellites; detecting whether the estimated vehicle position has reached an entry point of a tunnel or has reached a point before the entry point of the tunnel by a predetermined threshold distance; when the estimated vehicle position has reached said either one of points, immediately starting a map matching operation for matching a current vehicle position with a road link of the tunnel derived from a map database; and performing a Kalman filter processing by the integration Kalman filter on the position estimates of the INS and the current vehicle position obtained by the map matching operation thereby correcting errors caused by the vehicle sensors.

In the preferred embodiment, the method further includes steps of starting a normal navigation operation as soon as detecting that the vehicle has reached an exit point of the tunnel so that the map and navigation system is able to produce an absolute position of the vehicle based on the GPS signals, downloading the map data from a remote server to the smartphone so as to conduct the map matching operation to match the current vehicle position with a corresponding road link on the map data, and conducting a dead reckoning operation which calculates a current vehicle position based on a distance and a moving direction derived from output signals of the vehicle sensors with reference to a previously known absolute position.

The road link on the map data includes information on an attribute of the road and an absolute position of a node of each road link. The vehicle sensors include accelerometers and gyroscope which are created through a “micro-electro mechanical systems (MEMS)” technology for a purpose of vehicle stability and safety such that their precision is lower than sensors created for a purpose of INS. Output signals from the vehicle sensors are transmitted to the smartphone through a controlled area network (CAN) bus within the vehicle.

In the preferred embodiment, the predetermined threshold distance with respect to the entry point of the tunnel is determined by recording a first road link of the tunnel when the vehicle newly travels through the tunnel and setting a threshold distance before the first link to be used for later travel of the tunnel.

The integration of the INS and the map and navigation system is achieved by sending the position estimates of the map and navigation system to the integration Kalman filter thereby creating a loosely coupled INS/GPS navigation system. Alternatively, the integration of the INS and the map and navigation system is achieved by sending measurement raw data of the GPS signals derived from the map and navigation system to the integration Kalman filter thereby creating a tightly coupled INS/GPS navigation system.

Another aspect of the present disclosure is directed to a vehicle positioning apparatus for a navigation system established on a smartphone. The vehicle positioning apparatus detects a timing when the vehicle enters the tunnel and immediately starts the map matching operation and feedbacks the results of the map matching operation to accurately estimate the current vehicle position by implementing the various operational steps defined in the method of vehicle positioning noted above.

As has been described above, according to the vehicle positioning method and apparatus of the present disclosure, the INS/GPS navigation system can accurately estimate the current vehicle position when the vehicle travels through a tunnel that prevents GPS reception. The method and apparatus of vehicle positioning is triggered when a vehicle location is map matched onto a road link with a “tunnel” attribute. Until the vehicle exits the tunnel, IEKF calibration with the map matching feedback is conducted in order to correct the errors in a dead reckoning process caused by the low precision vehicle sensors.

### BRIEF DESCRIPTION OF THE DRAWINGS

FIG. 1A is a schematic diagram showing a basic idea of integrating a smartphone GPS device and an inertial navigation system (INS) using low-precision vehicle sensors, and FIG. 1B is a schematic diagram showing a situation where a vehicle having an integrated INS/GPS navigation system is approaching a tunnel.

FIGS. 2A and 2B are schematic diagrams each showing a basic functional structure of an embodiment of vehicle positioning system, where FIG. 2A is directed to a loosely coupled INS/GPS navigation system and FIG. 2B is directed to a tightly coupled INS/GPS navigation system.

FIGS. 3A and 3B are block diagrams each showing a more detailed configuration than that of FIG. 2A of the loosely coupled INS/GPS navigation system implemented by an off-board navigation system running on a smartphone and a plurality of vehicle sensors, where an embodiment of FIG. 3B includes additional components to that of FIG. 3A to improve gyroscope sensitivity.

FIG. 4 is a flow chart showing the operational steps for detecting a timing of vehicle's entry in a tunnel in accordance with the preferred embodiment of integrated INS/GPS navigation system.

FIG. 5 is a flow chart showing the operational steps for detecting a timing of vehicle's exit from the tunnel in accordance with the preferred embodiment of the integrated INS/GPS navigation system.

FIG. 6 is a schematic block diagram showing an overall configuration of the embodiment of the integrated INS/GPS navigation system with an emphasis on a computer configuration mainly associated with the smartphone for implementing the method of the present disclosure.

FIGS. 7A and 7B are schematic diagrams showing an example of topography in which a part of a street is a tunnel, where FIG. 7A shows a map in which a solid line represents the tunnel and FIG. 7B shows a map in which small dots represent actual positions of a vehicle.

FIGS. 8A and 8B are schematic diagrams showing estimated vehicle positions in the topographical situation of FIG. 7A, where FIG. 8A shows the estimated, vehicle position when map matching and IEKF calibration are not used and FIG. 8B shows the estimated vehicle position when the map-matching is used while the IEKF calibration is not used.

FIG. 9 is a schematic diagram showing estimated vehicle positions in the topographical situation of FIG. 7A where both the map matching and the IEKF calibration are applied using the technology of the present disclosure.

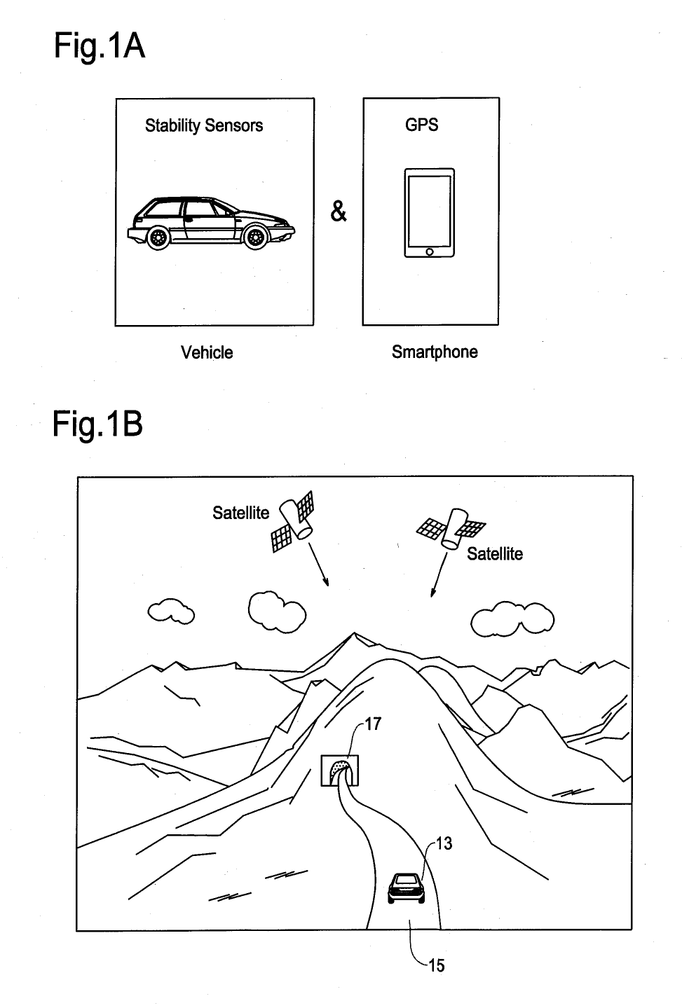

### DETAILED DESCRIPTION OF THE PREFERRED EMBODIMENTS

Various embodiments will be described hereinafter in detail with reference to the accompanying drawings. The present method of enhanced vehicle positioning is advantageously used in a navigation system where a smartphone with a GPS function is mounted on a vehicle having sensors for stability control, i.e., an off-board navigation system running on a smartphone. Within the context of the present disclosure, a smartphone is a mobile phone with more advanced computing and communication capability than basic mobile phones. A recent smartphone is equipped with various intelligent functions including a map and navigation function that accurately calculates geographical location by analyzing information contained in Global Positioning System (GPS) signals received from GPS satellites.

As noted above, some of current vehicles include processors, various sensors, and wired and/or wireless network in order to improve driving safety through vehicle stability control and accident protection. Sensors installed in a vehicle for this purpose include, for example, gyroscopes and three-dimensional accelerometers typically implemented in a form of Micro Electro Mechanical Sensors (MEMS). Although such accelerometers and gyroscopes installed in the vehicle do not have precision high enough for establishing an inertial navigation system (INS), the present disclosure is to use such vehicle sensors for establishing an INS combined with the GPS signals of the smartphone, i.e., an integrated vehicle sensor/GPS navigation system, to achieve a practical level of positioning accuracy.

Since such vehicle sensors are provided for the purpose of vehicle stability control rather than a conventional inertial navigation system (INS), the vehicle does not have a stand-alone INS function. Typically, specially made software may be installed in the smartphone to establish an INS using signals from the vehicle sensors when the smartphone is communicatively coupled to the vehicle. Hereafter, the vehicle sensors and a processor may also be referred to as “an inertial measurement unit (IMU)” that detects velocity, orientation, and/or gravitational forces.

While the description uses the term “smartphone” to be mounted to a vehicle, any other devices that have a map and navigation function and are connectable to a vehicle either with wire or wirelessly may utilize the present method. Efforts have been made to integrate the map and navigation system of the smartphone and the vehicle sensors. As known in the art, the map and navigation system and the INS complement with each other to utilize the advantages of the two individual systems and to overcome their weaknesses.

Typically, the map and navigation system to be executed on the smartphone receives Global Positioning System (GPS) signals from GPS satellites or another source and produces position data based on information contained in the GPS signals. The smartphone also obtains signals from the vehicle sensors like gyroscopes and accelerometers for vehicle stability which can be used as inertial sensors. The smartphone establishes an inertial navigation system (INS) by using the vehicle sensors and a Kalman filter, etc. and integrates INS data and the GPS-based position data, thereby establishing an integrated INS/GPS navigation system on the smartphone.

As noted above, the inertial sensors alone are able to provide relative positioning over an extended period of time. However, accumulation of drifting errors in an area where position data such as GPS signals are lost, e.g. inside a tunnel, can become severe, especially with low-accuracy sensors, since no GPS data in the area as measurements are available for calibration in Kalman filter (KF). Namely, compared to a dedicated vehicle navigation system, there are system level limitations that negatively impact on the accuracy in the INS/GPS navigation system on the smartphone.

First, dead reckoning (DR) suffers from error growth dramatically, due to low-accuracy data from gyroscopes for a vehicle stability purpose obtained through a controller area network (CAN) bus in the vehicle which are approximately 100 times less accurate than data from standard gyroscopes through CAN bus for a navigation purpose, and due to the fact that the data from gyroscopes and speed pulse signals through CAN bus are downsampled to a substantially low frequency (e.g., 2 Hz) at a head unit for processing capacity, when the gyroscope data and the speed pulse signals are received from CAN bus and transmitted to the smartphone by the head unit of the vehicle. Here, “dead reckoning” is an operation to obtain an estimated current position of the vehicle based on measured data from the low accuracy vehicle sensors. CAN bus is a vehicle bus standard to allow micro controllers and devices to communicate with each other within the vehicle.

Second, it is not reliable to evaluate GPS data availability and accuracy in a smartphone, because the GPS data based on GPS signals produced by the smartphone are in a low frequency (i.e., 1 Hz). Further, unlike a dedicated navigation system, the GPS data from the smartphone are not in the format of GPS NMEA protocol data, which is a data format defined by National Marine Electronics Association. Thus, the GPS data may lack information such as a number of satellites, pseudorange (the pseudo distance between a satellite and a navigation satellite receiver), pseudorange rate, etc., which would help to improve the accuracy of positioning data. While the drifting error accumulation in a tunnel is more prominent in the INS/GPS navigation system running on a smartphone, the same drifting error accumulation can occur in anyplace where GPS signals are lost or not good enough for KF calibration in any navigation system.

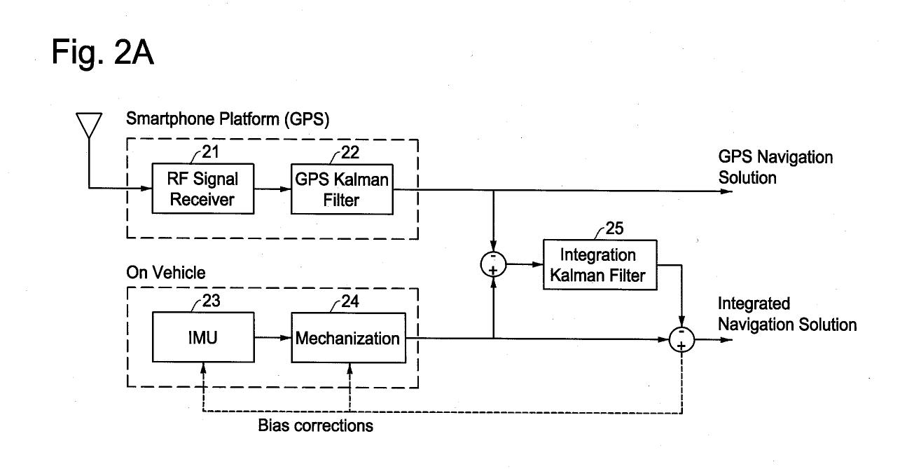

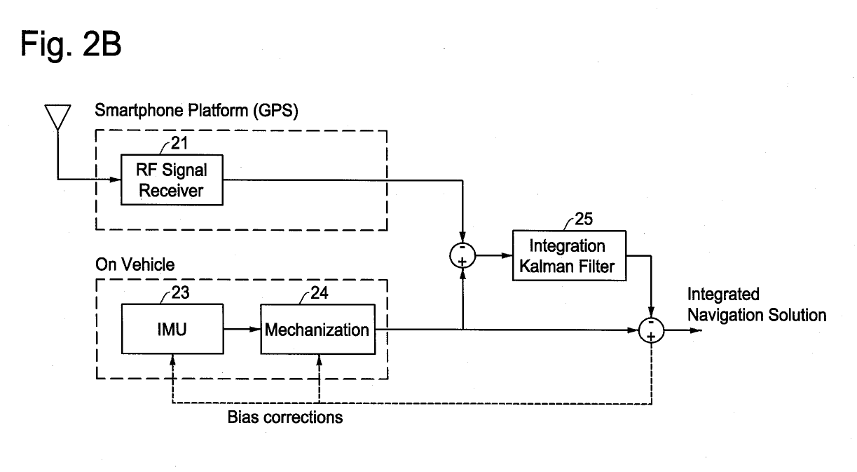

FIGS. 2A and 2B are schematic diagrams each showing a basic functional structure of an embodiment of vehicle positioning system which is able to solve the above-noted problems associated with the tunnel or otherwise GPS signal loss. FIG. 2A shows a structure of one embodiment directed to a loosely coupled INS/GPS navigation system and FIG. 2B shows a structure of the embodiment directed to a tightly coupled INS/GPS navigation system. Although the vehicle positioning disclosed here can be implemented either as a loosely coupled INS/GPS navigation system or a tightly coupled INS/GPS navigation system, since a typical GPS position solution is available by the smartphone, the loosely coupled integration may be preferable to fully use the existing functionalities of the smartphone.

As shown in FIG. 2A, the smartphone platform has a map and navigation function that receives GPS signals from, for example, more than four GPS satellites in the orbit, analyzes the GPS signals and produces a map and navigation data using position estimates. The smartphone platform includes a radio frequency (RF) signal receiver 21 which receives the GPS signals and produces raw measurement data (phase, time, etc.) and a GPS Kalman filter 22 which calculates the raw measurement data to produce the map and navigation data (position, velocity, etc). The map and navigation data can be independently used to display, for example, the current position, and can also integrate the inertial based information to obtain the final output of the integrated navigation system.

In FIG. 2A, the vehicle has an inertial measurement unit (IMU) 23 which is a set of sensors typically includes gyroscopes and three-dimensional accelerometers. Such sensors are small, low cost sensors typically manufactured by Micro Electro Mechanical (MEM) technologies in order to detect acceleration and angular rates of three coordinates of the vehicle. The vehicle also includes a mechanization unit 24 which functions as an IMU processor to obtain navigation related information, including but not limited to, position, velocity and direction, based on the acceleration and angular rates from the IMU 23.

The map and navigation data from the smartphone and the navigation information from the mechanization unit 24 are integrated by an integration Kalman filter 25. An example of the integration Kalman filter 25 is an iterated extended Kalman filter (IEKF) which executes linear as well as nonlinear state estimation. More specifically, the difference in the navigation data such as position and velocity between the map and navigation data from the smartphone and the navigation information from the mechanization unit 24 in an INS is used as an input to the integration Kalman filter 25. The integration Kalman filter 25 produces the final output of the integrated INS/GPS navigation system, in other words, integrated navigation data. The final output is provided as feedback via a closed loop to inputs of the IMU 23 and the mechanization unit 24 in order to correct errors of the sensors, such as bias offset errors.

The functional structure of FIG. 2B, which shows one embodiment of tightly coupled INS/GPS navigation system, is similar to that of FIG. 2A. However, in the navigation system of FIG. 2B, raw measurement data (phase, time, pseudorange, etc.) from the RF signal receiver 21 is directly used by the integration Kalman filter 25 which produces the integrated navigation data. Similar to the loosely coupled integration, the integrated navigation data is provided as feedback to inputs of the IMU 23 and the mechanization unit 24 in order to correct the errors of the low precision sensors.

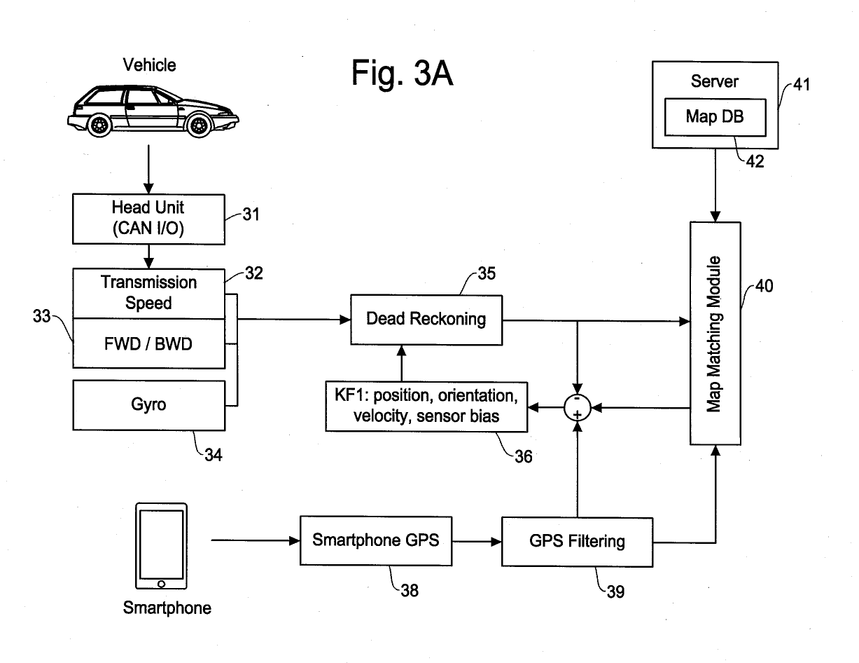

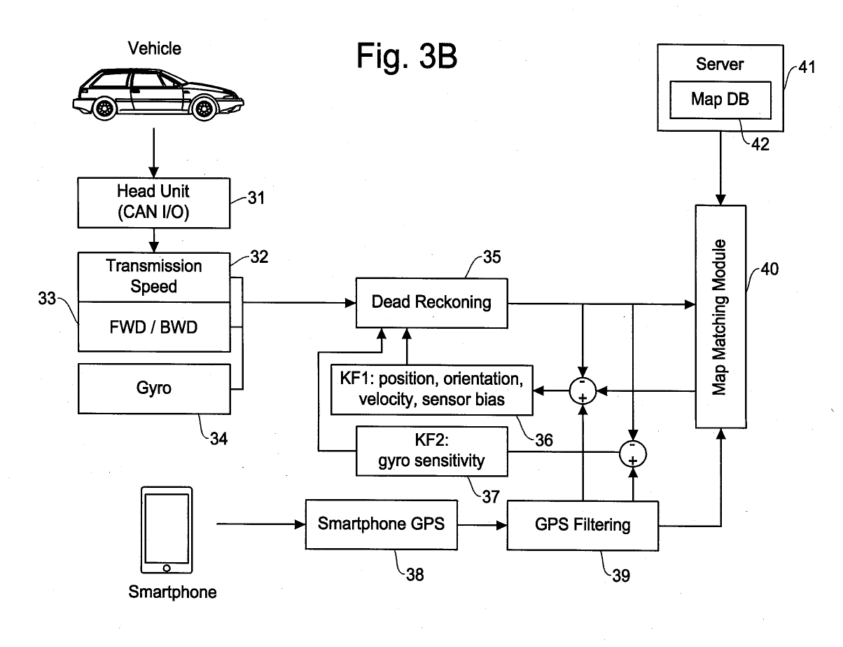

FIGS. 3A and 3B are block diagrams of the loosely coupled INS/GPS navigation systems each showing a more detailed configuration than that of FIG. 2A. The block diagrams of FIGS. 3A and 3B are illustrated for explaining the method and apparatus of vehicle positioning by using map matching during a dead reckoning operation when the vehicle is in an area where GPS signal loss is likely to occur, such as a tunnel, downtown with many high-rise buildings, valley between tall mountain walls, etc. The loosely coupled INS/GPS navigation systems of FIGS. 3A and 3B are implemented by an off-board navigation system running on the smartphone and a plurality of vehicle sensors. The configurations of FIGS. 3A and 3B are similar to one another, where an embodiment of FIG. 3B includes additional components to that of FIG. 3A to improve gyroscope sensitivity with use of a secondary Kalman filter 37.

In the configuration of FIG. 3A, the vehicle includes a head unit 31 which is typically a vehicle entertainment system with a display, CD player, DVD player, stereo system, etc. When the smartphone is brought in the vehicle, the head unit 31 may also function as an interface between the smartphone and a controller area network (CAN) bus within the vehicle via wireless or wired connection, such as Bluetooth. The vehicle also includes various sensors such as transmission speed sensors 32 such as accelerometers, forward/backward (FWD/BWD) sensors 33, and gyroscopes 34, among others, which correspond to the IMU 23 of FIGS. 2A and 2B. As noted above, since such vehicle sensors are not provided for the purpose of navigation, accuracy of the sensors is insufficient for a stand-alone inertial navigation system, thus there is need for technology of the present disclosure.

The signals obtained by the sensors 32-33 are sent to a dead reckoning module 35 which calculates a current vehicle position based on a distance and a moving direction based on acceleration and angular rate with reference to a known absolute position, typically, a position estimated by GPS. Such a distance and a moving direction will be calculated with use of the sensor signals, thus, the dead reckoning module 35 plays a major role in the inertial navigation system (INS). The smartphone is equipped with a smartphone GPS 38 which produces position estimation based on GPS signals from four or more GPS satellites. A GPS filter 39 is a GPS Kalman filter for executing a GPS filtering operation in order to improve accuracy of the position estimates from the smartphone GPS 38.

The result of the GPS filtering is sent to an integration Kalman filter 36 (KF1) which couples the smartphone GPS and the inertial navigation system (INS) using the vehicle sensors. As noted above, an example of the integration Kalman filter 36 is an iterated extended Kalman filter (IEKF) which covers the linear and nonlinear state estimation. The results including position, orientation, velocity, sensor bias, etc. of processing with the integration Kalman filter 36 (KF1) are sent to the dead reckoning module 35 to compensate the position estimate by the dead reckoning module 35 with reference to the absolute position estimated by the smartphone.

The example of FIG. 3A further includes a map matching module 40 which matches the estimated current position with a road link which is a road segment on the estimated route derived from a map database. As known in the art, in a map database, a road is defined by a plurality of road links connected with one another where each road link includes information on absolute position, such as longitude and latitude of each end or node and an attribute of the road. Upon receiving the position estimate from the dead reckoning module 35, the map matching module 40 matches the estimated position with the position indicated by the corresponding road links. The map matching result is provided as feedback to an input of the integration Kalman filter 36 via a closed loop in order to correct errors in the low precision vehicle sensors caused by errors, such as gyroscope bias errors.

In FIG. 3B, in addition to the same components of FIG. 3A, the embodiment includes a Kalman filter 37 (KF2) to improve gyroscope sensitivity. Namely, the Kalman filter 37 (KF2) is performed mainly for calibration to improve low accuracy of signals from gyroscopes through the controller area network (CAN) bus. Both in FIGS. 3A and 3B, a map database 42 is provided by a remote server 41 so that a portion of the map data, such as road links, etc., can be transmitted to the map matching module 40 of the smartphone through a wireless network such as Internet, although it is also possible that the smartphone pre-installs such a map database.

As noted above, the position estimation by the dead reckoning module 35 is periodically corrected by the absolute position estimated by the smartphone. However, appropriate GPS signals may not always be available, for example, in a downtown area with many tall buildings where the minimum number of visible GPS satellites may not be available. Especially, when the vehicle travels through a relatively long tunnel, no GPS signal is obtainable for a long period of time, thus, the position errors is likely be accumulated because the navigation system has to rely solely on the dead reckoning operation.

In the present disclosure, the map matching module 40 is provided in order to assist solving this problem by matching the estimated position with the position defined by the map data as well as by providing feedback regarding the matched position to an input of the integration Kalman filter 36. In the embodiments of FIGS. 3A and 3B, the method of vehicle positioning is triggered as soon as the vehicle detects that the vehicle enters the tunnel when a current vehicle position is map-matched with a position information indicating that the current vehicle position is on a road link with a “tunnel” attribute, regardless of whether the actual GPS signal loss is detected or not. On the other hand, the moment it is determined that the vehicle enters the tunnel, the map matching module 40 starts the operation of providing the last matched in-tunnel position to the vehicle positioning module. This operation is switched back to a normal vehicle positioning mode of the integrated INS/GPS navigation system as soon as it is detected that the vehicle exits the tunnel link.

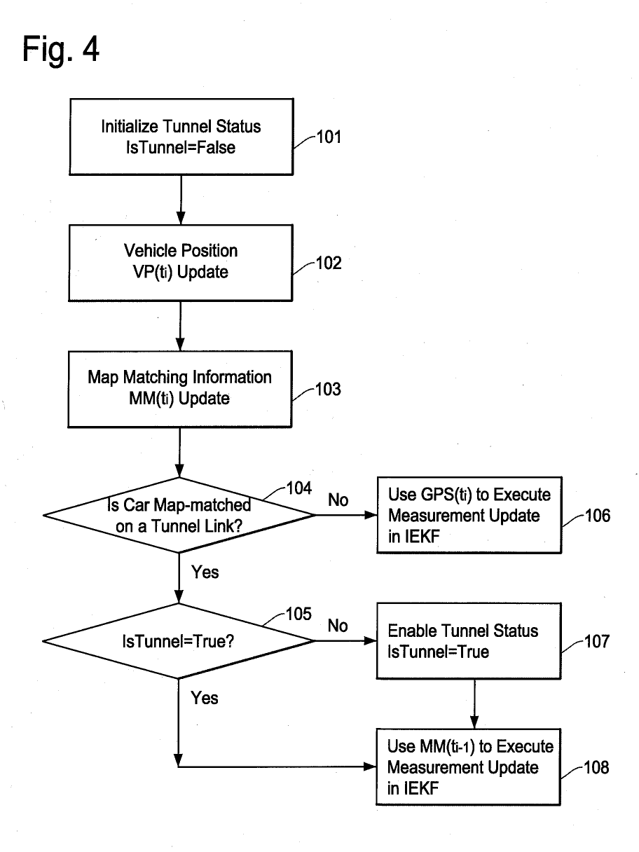

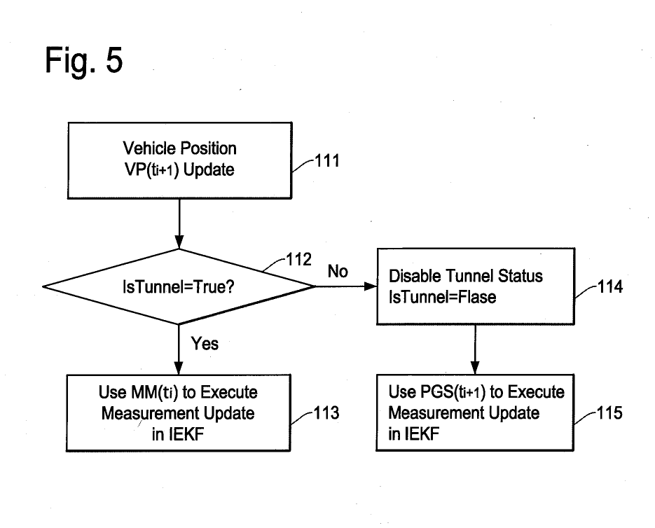

In the vehicle positioning method, two main stages are involved in the operational process as shown in the flow charts of FIGS. 4 and 5. FIG. 4 is a flow chart showing an example of operational steps for detecting a timing of vehicle's entry in a tunnel in accordance with the preferred embodiment of an integrated INS/GPS navigation system. FIG. 5 is a flowchart showing an example of operational steps for detecting a timing of vehicle's exit from the tunnel in accordance with the preferred embodiment of the integrated INS/GPS navigation system.

In the example of FIG. 4, initially, a tunnel status is set to false (step 101), i.e., “IsTunnel” flag is set to false, which indicates that the vehicle is not travelling through a tunnel. In step 102, the vehicle position VP(ti) is updated, i.e., the vehicle position is periodically estimated by the integrated INS/GPS navigation system. As noted above, the vehicle position is estimated by the smartphone and the dead reckoning module 35 shown in FIGS. 3A and 3B. At the same time, as in step 103, the map matching information MM(ti) is updated by the map matching module 40 thereby matching the current position with the position defined by the road link on the estimated route derived from the map database.

Specifically, the INS/GPS navigation system will determine whether the current vehicle position is map-matched with a road link of a tunnel. As noted above, each road may include a plurality of small road links or road segments where each road and its links are assigned with a corresponding attribute, such as a highway, freeway, one-way street, bridge, tunnel, etc. Each road link is also defined by its absolute position with respect to each end which is a node. Thus, in step 104, the INS/GPS navigation system checks the attribute of the road link or road segment that is currently map-matched so as to determine if the current vehicle position reaches the tunnel or arrives at a point on a link whose only successor link is a tunnel or arrives at a point that is within a predetermined threshold distance before the tunnel entrance. If the result in step 104 is negative, indicating that the vehicle is not on a tunnel link or close enough to the tunnel entrance, the INS/GPS navigation system will proceed to step 106 and use GPS(ti) to conduct measurement update in an iterated extended Kalman filter (IEKF). If the result in step 104 is affirmative, indicating that the vehicle is on a tunnel link or on a position close enough to the tunnel entrance, the INS/GPS navigation system will determine whether the tunnel status “IsTunnel” is true (step 105). Here, the tunnel status “IsTunnel=true” indicates that the vehicle has reached to the tunnel or within a threshold distance before the tunnel.

If the result in step 105 is negative where “IsTunnel” is not true, the INS/GPS navigation system will change the “IsTunnel” flag value to True in step 107. Then, the INS/GPS navigation system will use MM(ti−1), which is the previous map matching information, in executing the measurement update for the integration Kalman filter (IEKF) in step 108. Hereafter the measurement update using the map matching result may also be referred to as “IEKF calibration”. If the result in step 105 is affirmative where “IsTunnel” is true, the system will go to step 108 and execute the IEKF calibration. In this manner, the position estimate by the map-matching is provided as feedback for correcting the errors such as drifts in dead reckoning propagation when a previous map matching indicated that the vehicle was moving along the tunnel.

FIG. 5 is a flow chart showing operational steps to detect whether the vehicle is out of the tunnel or the vehicle is on a link whose only predecessor link is a tunnel. In step 111, the vehicle position VP(ti+1), which is an estimated vehicle position in the tunnel, is updated by the operations of the dead reckoning module 35 and the map matching module 40. Then, the INS/GPS navigation system will determine if “IsTunnel” is true indicating whether the vehicle is still in the tunnel, in step 112.

If the result in step 112 is negative, indicating that the vehicle is not on the road link of the tunnel link, the INS/GPS navigation system will set the IsTunnel status to be false in step 114. Then, the INS/GPS navigation system uses GPS(ti+1), which is the position estimate by the smartphone since the GPS signals are now recovered, to execute the measurement update of the integration Kalman filter in step 115. If the result is affirmative where “IsTunnel” is set True in step 112, then the INS/GPS navigation system will use MM(ti) indicative of the position estimate provided by the map matching module 40 in step 113, since the vehicle is still within the tunnel, in order to operate the measurement update of IEKF calibration. In this manner, until the vehicle exits the tunnel, the measurement update based on the map matching using the road links of the tunnel is executed in order to correct the position errors in the dead reckoning operation.

As described above, the algorithm of FIGS. 4 and 5 starts immediately at the entrance of the tunnel and ends immediately at the exit of the tunnel by detecting the position data of the road link and its attribute. The algorithm including the IEKF calibration is executed by using the position estimate produced by the map matching module 40 based on the tunnel road links in the map data as references. Normally GPS signals still can be received within a certain distance from an entrance or exit of a tunnel, however, such GPS signals are not reliable due to multipath effect as well as the fact that GPS loss is likely to happen soon enough. In addition, the repetition rate of the GPS position estimate is substantially low, such as 1 Hz, Therefore, it is beneficial to execute the IEKF calibration based on map matching feedback immediately when the vehicle is detected to be entering and to switch back to normal IEKF calibration until the end of tunnel. If the IEKF calibration using the map matching will not start until the actual GPS signal loss is detected by the navigation system, the accuracy of the position estimate would be negatively affected due to the errors accumulated before the GPS signal loss is detected. Further, as soon as the vehicle exits the tunnel, the algorithm immediately incorporating the GPS position estimate from the smartphone is executed to resume a normal navigation operation.

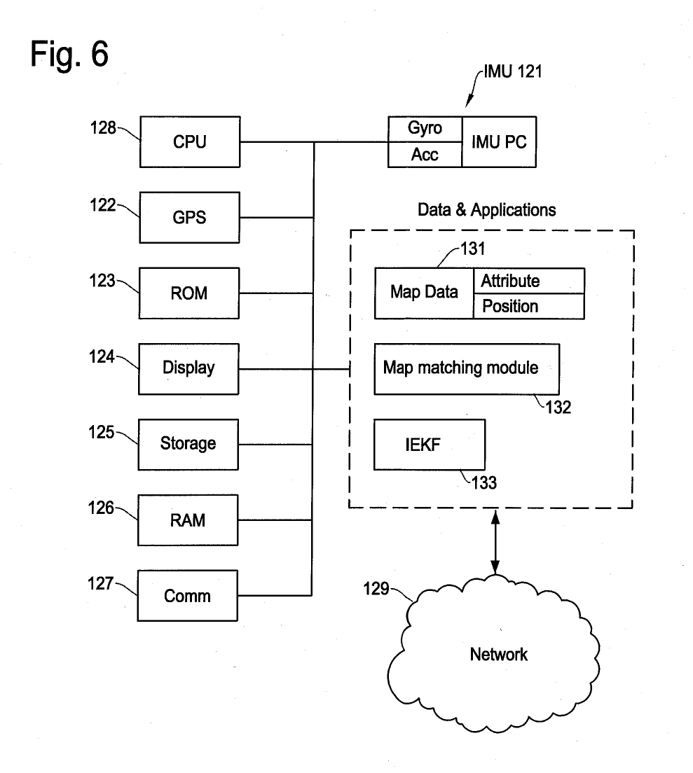

FIG. 6 is a schematic block diagram showing the basic configuration of the integrated INS/GPS navigation system implementing the vehicle positioning method and apparatus of the present disclosure. FIG. 6 is illustrated with an emphasis on a computer configuration mainly associated with the smartphone since the vehicle positioning disclosed here is likely be executed by the smartphone with use of the vehicle sensors. The integrated INS/GPS navigation system includes an inertial measurement unit (IMU) 121 having sensors such as gyroscopes and accelerometers mounted on a vehicle. Such vehicle sensors are small, low cost and low precision sensors typically created through Micro Electro Mechanical (MEM) technologies to detect acceleration and angular rates of three coordinates of the vehicle.

While the IMU 121 is mounted on the vehicle, the components designated by numerals 122-128 on the left side of FIG. 6 are typically mounted on the smartphone. A GPS 122 is a smartphone GPS receiver installed in a modern smartphone to estimate a current position based on the information derived from GPS signals. Read only memory (ROM) 123 is used to store basic operational program such as firmware of the smartphone. A display 124 is typically a liquid crystal display (LCD) touch screen configured as a graphic user interface. A storage device 125 stores programs that execute the operations described with reference to FIGS. 4 and 5 to execute the vehicle positioning when sufficient GPS signals are not available. Such programs may be downloaded to the smartphone through a communication network such as Internet.

Random access memory (RAM) 126 is used to temporarily store data and programs to execute the functions described in FIGS. 4 and 5 to operate the vehicle positioning when it is determined that the vehicle is in an area that sufficient GPS signals are unlikely to be available. A communication unit 127 allows a user of the smartphone to wirelessly communicate with another person or various service providers via a communication network. A central processing unit (CPU) 128 is a processor that controls overall operations of the smartphone as well as executes the special operation of the vehicle positioning by the INS/GPS navigation system described with reference to the flow charts of FIGS. 4 and 5.

Various data and function modules may be downloaded to the smartphone via a network 129 such as Internet to implement the method and apparatus of vehicle positioning of the present disclosure. A map data 131 may be provided by a remote server as illustrated in FIGS. 3A and 3B so that a portion of the map data, such as road links, etc., can be downloaded to the smartphone. The map data 131 includes link attributes that define a type of road represented by its respective road link and position information, such as longitude, latitude of each end or node of the road link. A map matching module 132 and an iterated extended Kalman filter (IEKF) 133 used for executing the vehicle positioning of the present disclosure may also be downloaded to the smartphone via the network 129. The map matching module 132 is a program that matches the vehicle positions with the road link defined in the map data. The IEKF 133 is a program that integrates the INS and the GPS and provides calibration to correct drifting of vehicle positions during the dead reckoning operation.

As noted above, in the preferred embodiment, the IMU 121 is furnished on a vehicle, and remaining components are typically provided in a smartphone. While components inside the vehicle are communicable with one another via a network such as a controller area network (CAN) bus that is a vehicle bus standard designed to allow micro controllers and devices to communicate with each other within a vehicle, inertial data from the IMU 121 retrieved from the CAN bus may be downsampled by a vehicle head unit (FIGS. 3A and 3B) and transmitted with wire or wirelessly to a smartphone via, for example, a Universal Serial Bus (USB) or Bluetooth.

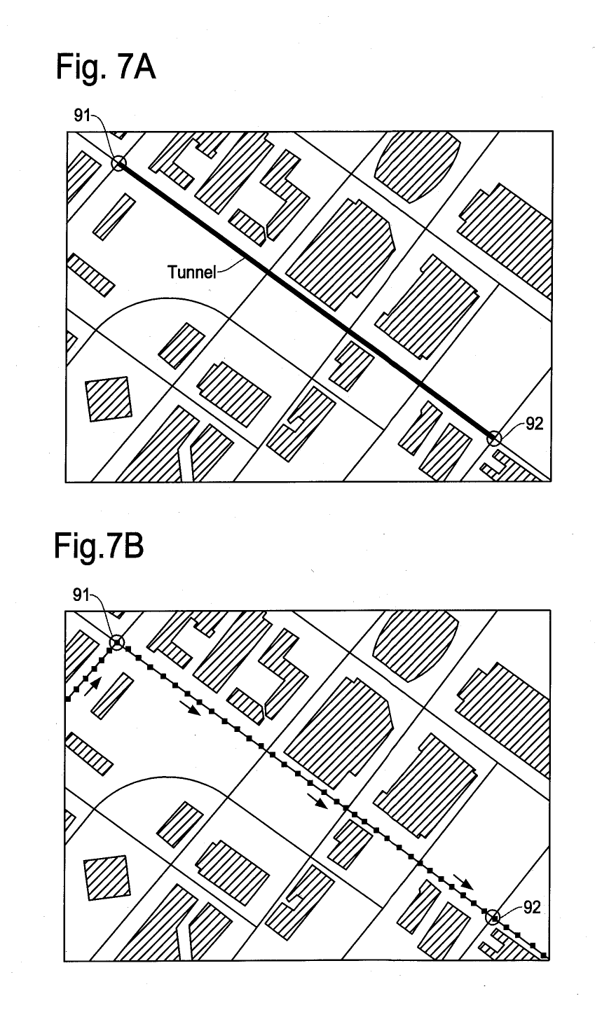

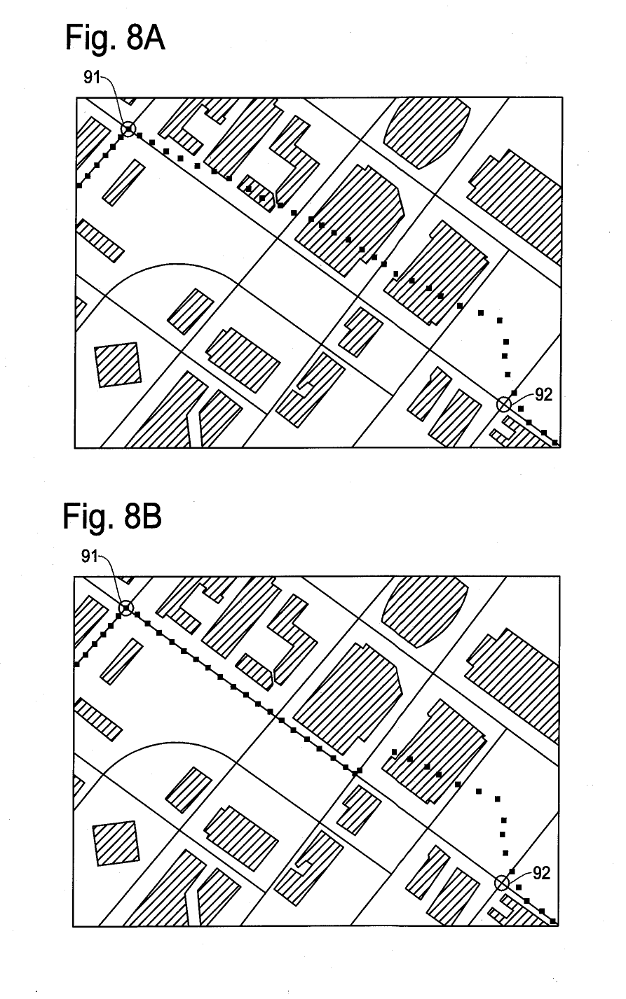

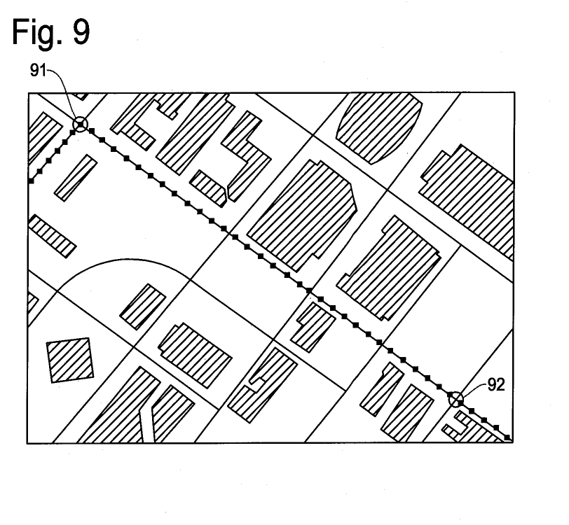

The effects of applying the enhanced vehicle positioning of the present technology in comparison to vehicle positioning without the present technology is described with reference to FIGS. 7A-7B, 8A-8B and 9 all of which are directed to the same topographical situation. FIGS. 7A and 7B show an example of topography in which a part of a street is a tunnel, where FIG. 7A shows a map in which a solid line represents the tunnel and FIG. 7B shows a map in which small dots represent the actual positions of a vehicle. FIG. 8A shows the estimated vehicle positions when map matching and IEKF calibration are not used and FIG. 8B shows the estimated vehicle positions when the map matching is used but the IEKF calibration is not used. FIG. 9 shows estimated vehicle positions where both the map matching and the IEKF calibration are applied using the technology of the present disclosure.

FIG. 7A shows a map wherein a part of the street is a tunnel as expressed by a solid line where an entry point 91 and an exit point 92 of the tunnel are represented by respective circles. The vehicle enters the tunnel at the entry point 91 and exits the tunnel at the exit point 92 during which no GPS signals can be received by the smartphone. FIG. 7B shows small dots on the map representing actual positions that the vehicle travels. Arrows are illustrated along the vehicle route to indicate the vehicle's travelling direction.

FIG. 8A shows the position estimates by the INS/GPS navigation system in a case where neither the map matching nor the IEKF calibration is used. As shown by the dots on the map, as the vehicle enters the tunnel at the entry point 91 and proceeds to the tunnel exit point 92, the estimated vehicle positions depart from the tunnel including actual positions of the vehicle. This is because GPS signal loss occurs soon after the vehicle enters the tunnel and the dead reckoning operation is not able to produce the accurate position estimates because of the low precision of the vehicle sensors. Finally, when the GPS signal becomes available when the vehicle passes the tunnel exit point 92, the correct estimated vehicle position is recovered.

FIG. 8B shows the position estimates by the INS/GPS navigation system in a case where the map matching is used while the IEKF calibration is not used. In this case, as the vehicle enters the tunnel, the map matching operation can produce correctly estimated vehicle positions which stay along the tunnel for a certain extent. However, as overdrift of estimated vehicle positions overly depart from the road due to the low precision of the vehicle sensors exceeds a threshold of map matching recovery, the estimated vehicle positions depart from the tunnel as shown by the sudden shifts Of the dots at around the middle of the tunnel. Thus, neither the method alone described in FIG. 8A nor the method described in FIG. 8B can provide the position estimates with high accuracy when the vehicle passes through the tunnel.

FIG. 9 shows the position estimates by the INS/GPS navigation system in a case where both the map matching and the IEKF calibration using the technology of the present disclosure are executed. In this case, as the navigation system uses the map matching and the IEKF calibration that are triggered by detecting an absolute position of the road link and a map attribute associated with high likeliness of GPS signal loss, such as a “tunnel” attribute, the estimated vehicle position is accurately placed along the link such as the tunnel. By immediately starting the map-matching and the IEKF calibration when detecting the “tunnel” attribute and its position of the road link, the INS/GPS navigation system can make accurate estimation of vehicle positions in a timely fashion. Since the repetition rate of the GPS position estimate is substantially low, such as 1 Hz, and particularly GPS signals received within a certain distance from the entrance or exit of the tunnel may be affected by multipath, it would be too late to wait until the GPS signal is detected as fully lost to start the map matching and the IEKF calibration like a conventional method of INS/GPS navigation. Namely, if the IEKF calibration using the map matching will not start until the actual GPS signal loss is detected by the navigation system as typically performed in the conventional navigation system, the accuracy of the position estimate would be negatively affected due to the errors accumulated before the GPS signals get fully lost and are detected. Thus, starting the map-matching and the IEKF calibration as soon as the vehicle has reached the entry point 91 of the tunnel or a point which at a predetermined threshold distance before the entry point 91 of the tunnel as described in the present disclosure is likely to significantly improve accuracy of position estimation when the vehicle is in an area where the GPS signal is likely to be lost.

The use of the algorithm described above with reference to FIGS. 4 and 5 is not limited to tunnels, but can be used to detect any locations where GPS signal loss is likely to pose similar problems. For instance, a location with high artificial structure such as buildings or high mountain walls may pose difficulty in receiving sufficient GPS signals, and the algorithm described above with reference to FIGS. 4 and 5 may be used to overcome the dead reckoning problems due to such GPS signal loss.

As has been described above, according to method of the present disclosure, the map matching as feedback used for IEKF calibration in the INS/GPS navigation system can accurately estimate the current vehicle position when the vehicle travels through a tunnel that prevents GPS reception. The method and apparatus of vehicle positioning is triggered when a vehicle location is map matched onto a road link with a “tunnel” attribute. Until the vehicle exits the tunnel, the IEKF calibration with the map matching feedback is conducted in order to correct the errors in the dead reckoning process caused by the low precision vehicle sensors.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A vehicle positioning method for a navigation system established on a smartphone with use of vehicle sensors, comprising the following steps of:
integrating, by using a processor, an inertial navigation system (INS) incorporating vehicle sensors with a map and navigation system implemented on a smartphone with use of an integration Kalman filter;
producing vehicle's position estimates by the INS based on the acceleration and angular rate measurements from the vehicle sensors;
producing position estimates indicating an absolute position of the vehicle by the map and navigation system which receives GPS satellite signals;
detecting whether the estimated vehicle position has reached an entry point of a tunnel or has reached a point before the entry point of the tunnel by a predetermined threshold distance;
when the estimated vehicle position has reached said either one of points, immediately starting a map matching operation for matching a current vehicle position with a road link of the tunnel derived from a map database; and
performing a Kalman filter processing by the integration Kalman filter on the position estimates of the INS and the current vehicle position obtained by the map matching operation thereby correcting errors caused by the vehicle sensors.

2. The vehicle positioning method as defined in claim 1, further comprising a step of starting a normal navigation operation as soon as detecting that the vehicle has reached an exit point of the tunnel so that the map and navigation system is able to produce an absolute position of the vehicle based on the GPS signals.

3. The vehicle positioning method as defined in claim 1, further comprising a step of downloading the map data from a remote server to the smartphone so as to conduct the map matching operation to match the current vehicle position with a corresponding road link on the map data.

4. The vehicle positioning method as defined in claim 1, wherein said road link on the map data includes information on an attribute of the road and an absolute position of a node of each road link.

5. The vehicle positioning method as defined in claim 1, wherein said step of producing vehicle's position estimates by the INS includes a step of conducting a dead reckoning operation which calculates a current vehicle position based on a distance and a moving direction derived from output signals of the vehicle sensors with reference to a previously known absolute position.

6. The vehicle positioning method as defined in claim 1, wherein said vehicle sensors include accelerometers and gyroscope which are created through a micro-electro mechanical systems (MEMS) technology for a purpose of vehicle stability and safety such that their precision is lower than sensors created for a purpose of INS.

7. The vehicle positioning method as defined in claim 1, further comprising:
transmitting output signals from the vehicle sensors to a head unit in a vehicle through a controlled area network (CAN).

8. The vehicle positioning method as defined in claim 7, further comprising:
downsampling the output signals from the vehicle sensors at the head unit and;
transmitting the downsampled output signals to the smartphone either with wire or wirelessly.

9. The vehicle positioning method as defined in claim 1, wherein said step of integrating the INS and the map and navigation system includes a step of sending the position estimates of the map and navigation system to the integration Kalman filter thereby creating a loosely coupled INS/GPS navigation system.

10. The vehicle positioning method as defined in claim 1, wherein said step of integrating the INS and the map and navigation system includes a step of sending measurement raw data of the GPS signals derived from the map and navigation system to the integration Kalman filter thereby creating a tightly coupled INS/GPS navigation system.

11. A vehicle positioning apparatus for a navigation system established on a smartphone with use of vehicle sensors, comprising:
an inertial navigation system (INS) incorporating vehicle sensors;
a map and navigation system implemented on a smartphone; and
a controller for controlling an overall operation of the vehicle positioning apparatus,
wherein the INS and the map and navigation system are integrated with one another by an integration Kalman filter,
wherein the INS is configured to produce vehicle's position estimates based on the acceleration and angular rate measurements from the vehicle sensors,
wherein the map and navigation system is configured to receive GPS satellite signals and to produce position estimates indicating an absolute position of the vehicle, and
wherein the controller is configured to detect whether the estimated vehicle position has reached an entry point of a tunnel or has reached a point before the entry point of the tunnel by a predetermined threshold distance, to immediately start a map matching operation for matching a current vehicle position with a road link of the tunnel derived from a map database when the estimated vehicle position has reached said either one of points, and to perform a Kalman filter processing by the integration of Kalman filter on the position estimates of the INS and the current vehicle position obtained by the map matching operation thereby correcting errors caused by the vehicle sensors.

12. The vehicle positioning apparatus as defined in claim 11, said controller is further configured to start a normal navigation operation as soon as detecting that the vehicle has reached an exit point of the tunnel so that the map and navigation system is able to produce an absolute position of the vehicle based on the GPS signals.

13. The vehicle positioning apparatus as defined in claim 11, said controller is further configured to control an operation of downloading the map data from a remote server to the smartphone so as to conduct the map matching operation to match the current vehicle position with a corresponding road link on the map data.

14. The vehicle positioning apparatus as defined in claim 11, wherein said road link on the map data includes information on an attribute of the road and an absolute position of a node of each road link.

15. The vehicle positioning apparatus as defined in claim 11, wherein, with respect to producing vehicle's position estimates by the INS, said controller is further configured to conduct a dead reckoning operation which calculates a current vehicle position based on a distance and a moving direction derived from output signals of the vehicle sensors with reference to a previously known absolute position.

16. The vehicle positioning apparatus as defined in claim 11, wherein said vehicle sensors include accelerometers and gyroscope which are created through a micro-electro mechanical systems (MEMS) technology for a purpose of vehicle stability and safety such that their precision is lower than sensors created for a purpose of INS.

17. The vehicle positioning apparatus as defined in claim 11, wherein output signals from the vehicle sensors are transmitted to a head unit via controlled area (CAN) network and to the smartphone.

18. The vehicle positioning apparatus as defined in claim 17, wherein the head unit is configured to downsample the output signals from the vehicle sensors and to transmit the downsampled output signals to the smartphone either wired or wirelessly.

19. The vehicle positioning apparatus as defined in claim 11, wherein said integration of the INS and the map and navigation system is achieved by sending the position estimates of the map and navigation system to the integration Kalman filter thereby creating a loosely coupled INS/GPS navigation system.

20. The vehicle positioning apparatus as defined in claim 11, wherein said integration of the INS and the map and navigation system is achieved by sending measurement raw data of the GPS signals derived from the map and navigation system to the integration Kalman filter thereby creating a tightly coupled INS/GPS navigation system.
